(19) United States
(12) Patent Application Publication
(10) Pub. No.: US 2009/0103851 A1
(43) Pub. Date: Apr. 23, 2009

(54) SURFACE PLASMON RESONANCE FIBER SENSOR

(75) Inventors: Yu-Chia TSAO, Taipei City (TW); Yi-Wen Yang, Taipei City (TW); Jou-Kai Tai, Taipei City (TW); Woo-Hu Tsai, Taipei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: Forward Electronics Co., Ltd., Taipei City (TW)

(21) Appl. No.: 12/121,868

(22) Filed: May 16, 2008

(30) Foreign Application Priority Data
Oct. 22, 2007 (TW) 096139458

(51) Int. Cl. G02B 6/00; G01N 21/00

(52) U.S. Cl. 385/12; 356/73

(57) ABSTRACT

A Surface Plasmon Resonance (SPR) fiber sensor is disclosed, which comprises an optical fiber member and a plurality of optical fiber sensing units. Each of the plurality of the optical fiber sensing units comprises a cladding layer, a core layer, and a groove, and the plurality of the optical fiber sensing units is arranged into a cascade form matrix. In each of the optical fiber sensing units, the cladding layer is located at the periphery of the core layer, and the maximum depth of the groove is larger than the thickness of the cladding layer. An SPR sensing apparatus is also disclosed, which includes a light source, an optical signal detector, a plurality of fibers, and a plurality optical fiber sensing units. Besides, the optical fiber sensing units, the light source, and the optical signal detector are connected with each other through the plurality of fibers.

### BACKGROUND OF THE INVENTION

1. Field of the Invention

The present invention relates to a surface plasmon resonance fiber sensor and, more particularly, to a surface plasmon resonance fiber sensor having plural optical fiber sensing units arranged into a cascade form matrix, wherein the surface plasmon resonance fiber sensor is easy to operate, easily portable, having higher resolution and analyzing sensitivity, and being able to be applied in a surface plasmon resonance sensing apparatus.

2. Description of Related Art

Currently, in the medical detecting field or environment detecting field, it is important to detect immediately and accurately the kind and the concentration of a biomolecule under test. For example, in a site having a leakage of hazardous material, it is extremely important for the emergency management team to on-site identify the kind of the hazardous material and the concentration thereof immediately and accurately, in order to determine which is the proper procedure to solve the leakage situation and minimize the risk to the processing process. Therefore, it is important to improve the accuracy and sensitivity of the analyzing apparatus, to simplify the detecting process, and to improve the portability of the analyzing apparatus.

FIG. 1 is a schematic drawing of the conventional surface plasmon resonance sensing apparatus. The conventional surface plasmon resonance sensing apparatus includes an incident light source 11, an incident light processing unit 12, a prism 13, a metallic layer 14, an optical detector 15, a DUT supporting unit 16 and a spectrometer 17, wherein the light source 11 is a laser diode, the incident light processing unit 12 further comprises a beam profile expander 121, a polarizer 122, a splitter 123, and a focusing lens 124. Therefore, after passing through the incident light processing unit 12, the light previously emitted from the light source 11 will have some specific characteristics, such as certain frequency, certain mode and certain polarization, for the detection purpose. Besides, the metallic layer 14 is formed on the back surface of the prism 13 by depositing gold particles or silver particles, in way of sputtering or evaporation. When the conventional surface plasmon resonance sensing apparatus is being operated, the light emitted from the light source 11 first passes through the light processing unit 12, then the light reaches the first side surface 131 of the prism 13. Later, the light is reflected by the metallic layer 14 and departs the prism 13 through the second side surface 132. The light then arrives at the optical detector 15 which transfers the light into corresponding voltage signal, for the spectrometer 17 to analyze the variation of the spectrum distribution. However, since the size of the conventional surface plasmon resonance sensing apparatus is quite large, and for normal operation, the relative position relation between all of the elements thereof must be carefully maintained the same during the whole detection process, the conventional surface plasmon resonance sensing apparatus is almost zero-tolerated to the vibration and is easily destroyed by impact. Therefore, the conventional surface plasmon resonance sensing apparatus is not suitable for an emergency management team to take to a site with them.

FIG. 2 is a schematic drawing showing the conventional surface plasmon resonance sensor applied in a surface plasmon resonance sensing apparatus. The conventional surface plasmon resonance sensing apparatus comprises: a light source 22, a sample tank 23 having a fiber bio-detecting unit (not shown) therein, a light detector 24, plural fibers 221, 222, and a computing display unit (not shown) connected with the light detector 24, wherein the fibers 221, 222 are connected with the light source 22, the fiber bio-detecting unit (not shown), and the light detector 24, respectively. The light detector 24 receives the light signal passing through the fiber bio-detecting unit (not shown) and transmits the corresponding voltage signal to the computing display unit (not shown). The computing display unit (not shown) then displays the result on the display device thereof. The conventional surface plasmon resonance sensing apparatus shown in FIG. 2 is easily portable, easy to operate, and its bio-detecting unit (not shown) is easily exchangeable. As a result, an emergency management team can take it to the site and operate it on the site. It is a yet another object to further improve the sensitivity and the resolution of the detection performed by this conventional surface plasmon resonance sensing apparatus.

Therefore, a surface plasmon resonance sensing apparatus which is portable, easy to operate, and with an easily exchangeable bio-detecting unit is required. Besides, a surface plasmon resonance sensing apparatus with a higher detecting accuracy is also required.

### SUMMARY OF THE INVENTION

The object of the present invention is to provide a surface plasmon resonance fiber sensor, which can lower noise occurring during the detection operation, improve the accuracy of the detection, and have the following advantages: shortened detection time, pre-labeling on the DUT before the detection being not required, only a small amount of sample being required, on-line detection of the interaction between the DUT and the corresponding ligand being possible, and the sensitivity of the detection being high.

Another object of the present invention is to provide a surface plasmon resonance sensing apparatus, which is easily portable, easy to operate, has a bio-detecting unit that is easily exchangeable, and has lower detecting noise and higher detecting accuracy.

To achieve the above objects, the surface plasmon resonance fiber sensor of the present invention comprises: an optical fiber member; and a plurality of optical fiber sensing units, each of the optical fiber sensing units having a cladding layer, a core layer, and a groove; wherein the plurality of the optical fiber sensing units is arranged into a cascade form matrix, the cladding layer is located at the periphery of the core layer, the maximum depth of the groove is larger than the thickness of the cladding layer, and the optical fiber member is connected with the optical fiber sensing units.

The optical fiber member of the surface plasmon resonance fiber sensor of the present invention can be a single-mode fiber or a multi-mode fiber, but preferably it is a multi-mode fiber.

According to one aspect of the present invention, the optical fiber member of the surface plasmon resonance fiber sensor can be connected with the optical fiber sensing units at the ends of the cascade form matrix through a welding process, or the optical fiber member and the optical fiber sensing units can be integrated as a whole.

According to another aspect of the present invention, the groove of each of the optical fiber sensing units of the surface plasmon resonance fiber sensor can be formed by any kind of process, but preferably it is formed by applying a side polishing process or an etching process on the optical fiber member. Besides, the surface of the groove of each of the optical fiber sensing units is preferably a polished surface. The length of the polished surface is not limited, but preferably the length is between 0.2 mm to 0.7 mm. The plurality of the optical fiber sensing units of the surface plasmon resonance fiber sensor of the present invention is arranged into a cascade form matrix, and the maximum depth of the groove of each of the optical fiber sensing units can be same with, or different from each other, preferably the maximum depths of the grooves of two neighboring optical fiber sensing units are the same.

According to still another aspect of the present invention, the surfaces of the grooves having the maximum depth of the plurality of the optical fiber sensing units of the surface plasmon resonance fiber sensor can be parallel or non-parallel with each other, but preferably the surfaces of the grooves having the maximum depth of two neighboring optical fiber sensing units are parallel with each other.

According to still another aspect of the present invention, the distance between the grooves of two neighboring optical fiber sensing units of the surface plasmon resonance fiber sensor is not limited, but preferably the distance between the grooves of two neighboring optical fiber sensing units is the same.

According to still another aspect of the present invention, the surfaces of the grooves of each of the plurality of the optical fiber sensing units of the surface plasmon resonance fiber sensor can be coated with any kind of metallic layer, but preferably the metallic layer is made of gold or silver. Besides, the thickness of the metallic layer is not limited, but preferably the thickness is between 10 nm to 60 nm. Moreover, the thickness of the metallic layer coated on the surface of the grooves of two neighboring optical fiber sensing units can be same with, or different from each other, but preferably the thicknesses of the metallic layer coated on the surface of the grooves of two neighboring optical fiber sensing units are the same as each other.

On the other hand, a biomolecule layer can be formed on the surface of the groove of each of the plurality of the optical fiber sensing units of the surface plasmon resonance fiber sensor. Besides, the biomolecule layer can also be formed on the surface of the metallic layer located on the surface of groove of each of the plurality of the optical fiber sensing units.

The surface plasmon resonance sensing apparatus of the present invention comprises: a light source; an optical signal detector; a plurality of fibers; a plurality of optical fiber sensing units, each of the optical fiber sensing units having a cladding layer, a core layer, and a groove; wherein the plurality of the optical fiber sensing units is arranged into a cascade form matrix, the cladding layer is located at the periphery of the core layer, the maximum depth of the groove is larger than the thickness of the cladding layer, and the plurality of the optical fiber sensing units is respectively connected with the light source and the optical signal detector by the plurality of fibers. The light source of the surface plasmon resonance sensing apparatus of the present invention can be any kind of light source, but preferably it is a laser diode.

According to one aspect of the present invention, the groove of each of the plurality of optical fiber sensing unit of the surface plasmon resonance sensing apparatus can be coated with any kind of metallic layer, but preferably the metallic layer is made of gold or silver. Besides, a biomolecule layer can also be formed on the surface of the groove of each of the plurality of optical fiber sensing unit of the surface plasmon resonance sensing apparatus of the present invention.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the conventional surface plasmon resonance sensing apparatus;

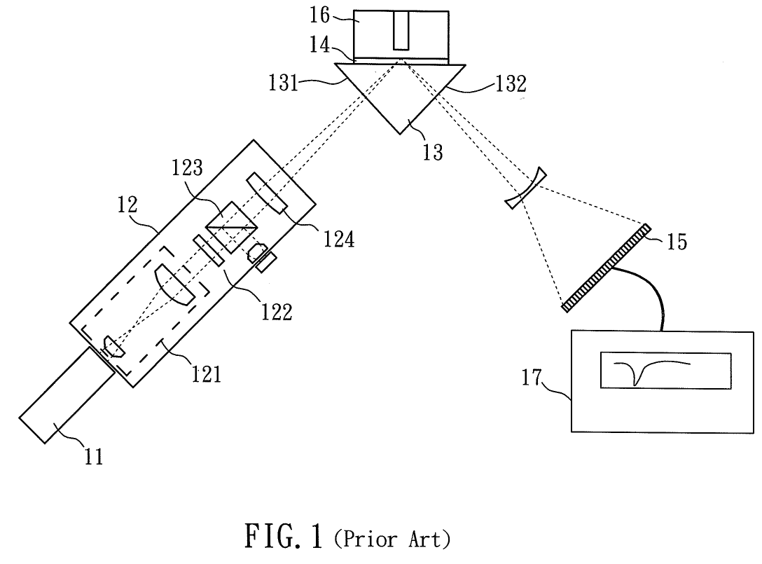

FIG. 2 is a schematic drawing showing the conventional surface plasmon resonance sensor applied in a surface plasmon resonance sensing apparatus;

FIG. 3 is a schematic drawing of one preferred embodiment of a surface plasmon resonance fiber sensor according to the present invention;

FIG. 4 is a schematic drawing of another preferred embodiment of a surface plasmon resonance fiber sensor according to the present invention; and

FIG. 5 is a schematic drawing showing the results of the detection of the surface plasmon resonance sensing apparatus according to the present invention.

### DETAILED DESCRIPTION OF THE PREFERRED EMBODIMENT

### Embodiment 1

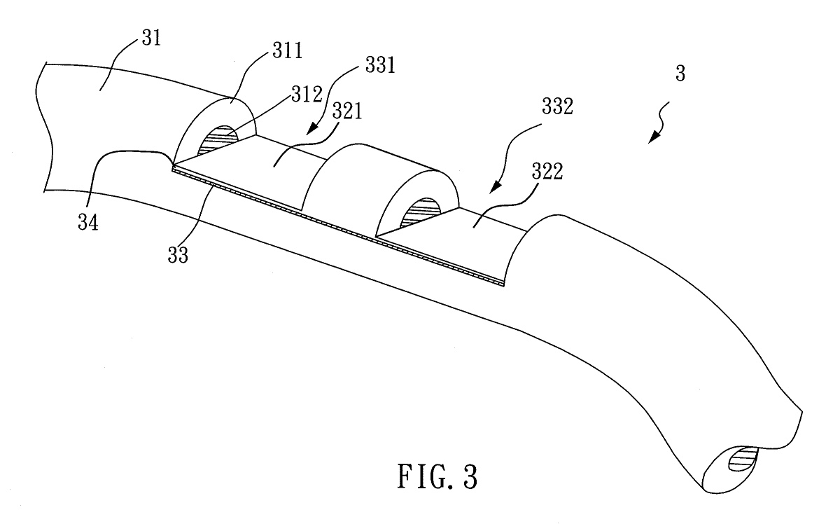

FIG. 3 is a schematic drawing of one preferred embodiment of a surface plasmon resonance fiber sensor according to the present invention. The surface plasmon resonance fiber sensor 3 comprises an optical fiber member 31, a first sensing unit 321, and a second sensing unit 322, wherein the optical fiber member 31 is a multi-mode fiber, and the first sensing unit 321 and a second sensing unit 322 are arranged in a cascade form matrix. Besides, the aforementioned optical fiber member and the optical fiber sensing units of the surface plasmon resonance fiber sensor 3 are integrated as a whole. In the present embodiment, the first sensing unit 321 and the second sensing unit 322 are formed by executing a polishing process on the optical fiber member 31. A first groove 331 and a second groove 332 are thus formed and arranged in a cascade form matrix, wherein the polishing length of each of these two grooves is about 0.5 mm. Moreover, the maximum depths of these two grooves are larger than the thickness of the cladding layer 311 of the optical fiber member 31, in order to expose the core layer 312 of the optical fiber member 31.

It should be noted that the number of the grooves formed on the optical fiber sensing units of the optical fiber member is not limited. In the present embodiment, the first groove 331 and the second groove 332 are arranged in a cascade form matrix. That is, in other embodiments, the number of the optical fiber sensing units may be varied, depending on the samples to be detected or the environment in which the detection is executed. Moreover, for improving the intensity of the surface plasmon resonance signal and the stability of the bonding of the sample on the optical fiber sensing units, a metallic layer 34 can be formed on the surface of the first groove 331 and that of the second groove 332 by a sputtering process or other deposition methods. In the present embodiment, the metallic layer 34 is made of gold and the thickness thereof is about 40 nm. Moreover, the surface of the first groove 331 having the maximum depth is parallel with the surface of the second groove 332 having the maximum depth, and the maximum depths of these two grooves are the same. However, in other embodiments, depending on the samples to be detected or the environment in which the detection is executed, the surfaces of these grooves can be non-parallel with each other, and the maximum depths of these grooves may be different from each other.

### Embodiment 2

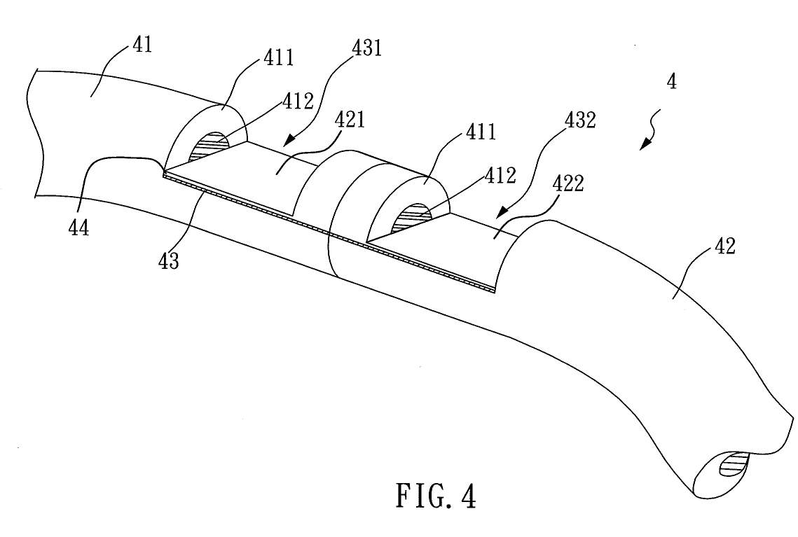

FIG. 4 is a schematic drawing of another preferred embodiment of a surface plasmon resonance fiber sensor according to the present invention. The surface plasmon resonance fiber sensor 4 comprises a first optical fiber member 41, a second optical fiber member 42, a first sensing unit 421, and a second sensing unit 422, wherein the first optical fiber member 41 and the second optical fiber member 42 are both multi-mode fibers, and the first sensing unit 421 and the second sensing unit 422 are formed on the first optical fiber member 41 and the second optical fiber member 42, respectively. Besides, the first sensing unit 421 and the second sensing unit 422 are arranged in a cascade form matrix. Being different from the previous embodiment, the aforementioned sensing units and the optical fiber members are connected through a welding process. In the present embodiment, the first sensing unit 421 and the second sensing unit 422 are formed by executing a polishing process on the first optical fiber member 41 and the second optical fiber member 42, respectively, wherein the first sensing unit 421 and the second sensing unit 422 have a first groove 431 and a second groove 432, respectively. After the welding process is executed, the first groove 431 and the second groove 432 are arranged in a cascade form matrix, wherein the polishing length of these two grooves is about 0.5 mm. Moreover, the maximum depths of these two grooves are larger than the thickness of the cladding layer 411 of both the first optical fiber member 41 and the second optical fiber member 42, in order to expose the core layer 412 of both the first optical fiber member 41 and the second optical fiber member 42.

It should be noted that the number of the grooves formed on the optical fiber sensing units of the optical fiber member is not limited. In the present embodiment, the first groove 431 and the second groove 432 are arranged in a cascade form matrix. That is, in other embodiment, the number of the optical fiber sensing units may be varied, depending on the samples to be detected or the environment in which the detection is executed. Moreover, for improving the intensity of the surface plasmon resonance signal and the stability of the bonding of the sample on the optical fiber sensing units, a metallic layer 44 can be formed on the surface of the first groove 431 and that of the second groove 432 by a sputtering process or other deposition methods. In the present embodiment, the metallic layer 44 is made of gold and the thickness thereof is about 40 nm. Moreover, the surface of the first groove 431 having the maximum depth is parallel with the surface of the second groove 432 having the maximum depth, and the maximum depths of these two grooves are the same. But, in other embodiments, depending on the samples to be detected or the environment in which the detection is executed, the surfaces of these grooves can be non-parallel with each other, and the maximum depths of these grooves may be different from each other.

### Embodiment 3

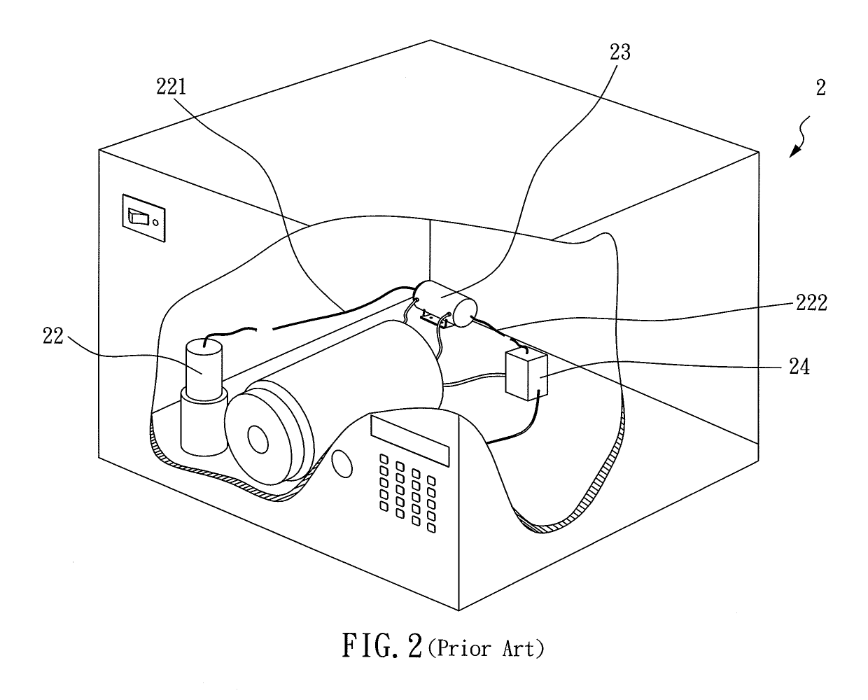

In the present embodiment, the surface plasmon resonance fiber sensor of the present invention is applied in a surface plasmon resonance sensing apparatus, wherein the surface plasmon resonance sensing apparatus can be the one being used in the prior art application. The surface plasmon resonance sensing apparatus of the present invention will be explained in the following, along with FIG. 2 of the present invention.

The surface plasmon resonance sensing apparatus of the present invention comprises a laser diode 22 as a light source, and the light emitted from the laser diode 22 is guided and incident into a sample tank 23 through a multi-mode fiber 221, wherein the surface plasmon resonance fiber sensor of the present invention (not shown) is installed in the sample tank 23. An optical signal detector 24 is connected with the optical fiber sensing unit (not shown) through another multi-mode fiber 222. The optical signal detector 24 transfers the light it received into corresponding voltage signals and transmits the voltage signals to a computing control unit (not shown), for analyzing and computing purpose.

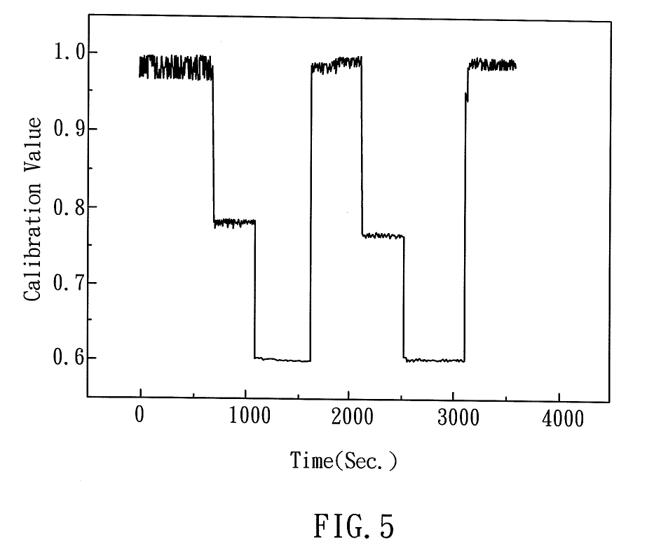

FIG. 5 is a schematic drawing showing the results of the detection of the surface plasmon resonance sensing apparatus according to the present invention, wherein the sample under test is alcohol drops and the results of the detection can be displayed, in view of the variations of the peak values of the signal intensity. As shown in the figure, the curve having the peak values (the calibration value) about 1.0 shows the results of the original light source, the curve having the peak values (the calibration value) about 0.75 shows the results of the conventional surface plasmon resonance fiber sensor equipped with only one optical fiber sensing unit, and the curve having the peak values (the calibration value) about 0.6 shows the results of the surface plasmon resonance fiber sensor according to the first or second embodiment of the present invention equipped with two optical fiber sensing units arranged into a cascade form matrix.

Therefore, as shown in FIG. 5, since the optical fiber sensing units of the surface plasmon resonance fiber sensor of the present invention are arranged into a cascade form matrix, the noise part of the detection signal, i.e. the surface plasmon resonance signal, can be effectively reduced after the calibration process to the detection signal has been executed. As a result, the resolution of the analyzation of the detection signal can also be increased.

In summary, the surface plasmon resonance fiber sensing method can have the following advantages, the pre-labeling on the DUT before the detection is not required, only a small amount of sample is required, the on-line detection of the interaction between the DUT and the corresponding ligand is possible, and the sensitivity of the detection is high. Thus, the surface plasmon resonance fiber sensing method can be applied in various fields, such as, detection on chemical gas or the solution having waste therein, monitoring on the polluted material, immunity medicine, and the filtration of disease. The Kretschmann-Raether method is an example of the conventional surface plasmon resonance fiber sensing method, wherein a prism, a thin layer of metallic material and a dielectric layer having the DUT therein are involved. However, the sensitivity and the resolution of the Kretschmann-Raether method cannot be effectively increased. On the contrary, by having plural optical fiber sensing unit arranged into a cascade form matrix, the surface plasmon resonance fiber sensor of the present invention can also have the advantages described above, such as, having the sensitivity higher than that of the conventional surface plasmon resonance fiber sensor, on-line and fast detection being possible, and having lower noise on the detection signal. Therefore, the cost and time of the detection process applying the surface plasmon resonance fiber sensor of the present invention can be reduced and shortened, respectively. Besides, the process of the surface plasmon resonance fiber sensing method of the present invention is also simplified.

Although the present invention has been explained in relation to its preferred embodiment, it is to be understood that many other possible modifications and variations can be made without departing from the scope of the invention as hereinafter claimed.

1. A surface plasmon resonance fiber sensor, comprising:
an optical fiber member; and
a plurality of optical fiber sensing units, each of the optical fiber sensing units having a cladding layer, a core layer, and a groove;
wherein the plurality of the optical fiber sensing units are arranged into a cascade form matrix, the cladding layer is located at the periphery of the core layer, a maximum depth of the groove is larger than a thickness of the cladding layer to expose at least a vertical-section surface of the core layer, and the optical fiber member is connected with the optical fiber sensing units.

2. The surface plasmon resonance fiber sensor as claimed in claim 1, wherein the optical fiber member is connected with the optical fiber sensing units at the ends of the cascade form matrix through a welding process.

3. The surface plasmon resonance fiber sensor as claimed in claim 2, wherein the optical fiber member is connected with the optical fiber sensing units at the ends of the cascade form matrix, and the optical fiber member and the optical fiber sensing units are integrated as a whole.

4. The surface plasmon resonance fiber sensor as claimed in claim 1, wherein the surface of the groove of each of the optical fiber sensing units is a polished surface.

5. The surface plasmon resonance fiber sensor as claimed in claim 1, wherein the groove of each of the optical fiber sensing units is formed by a side polishing process or an etching process.

6. The surface plasmon resonance fiber sensor as claimed in claim 4, wherein the length of the polished surface is between 0.2 mm to 0.7 mm.

7. The surface plasmon resonance fiber sensor as claimed in claim 1, wherein the optical fiber member is a multi-mode fiber.

8. The surface plasmon resonance fiber sensor as claimed in claim 1, wherein the surface of the groove is coated with a metallic layer.

9. The surface plasmon resonance fiber sensor as claimed in claim 8, wherein the thickness of the metallic layer is between 10 nm to 60 nm.

10. The surface plasmon resonance fiber sensor as claimed in claim 8, wherein the metallic layer is made of gold or silver.

11. The surface plasmon resonance fiber sensor as claimed in claim 1, wherein a biomolecule layer is formed on the surface of the groove.

12. The surface plasmon resonance fiber sensor as claimed in claim 8, wherein a biomolecule layer is formed on the surface of the metallic layer.

13. The surface plasmon resonance fiber sensor as claimed in claim 1, wherein the maximum depths of the grooves of two neighboring optical fiber sensing units are the same.

14. The surface plasmon resonance fiber sensor as claimed in claim 1, wherein the surfaces of the grooves having the maximum depth of two neighboring optical fiber sensing units are parallel with each other.

15. The surface plasmon resonance fiber sensor as claimed in claim 1, wherein the distance between the grooves of two neighboring optical fiber sensing units is the same.

16. The surface plasmon resonance fiber sensor as claimed in claim 8, wherein the thickness of the metallic layer of the grooves of two neighboring optical fiber sensing units is the same.

17. A surface plasmon resonance sensing apparatus, comprising:
a light source;
an optical signal detector;
a plurality of fibers;
a plurality of optical fiber sensing units, each of the optical fiber sensing units having a cladding layer, a core layer, and a groove;
wherein the plurality of the optical fiber sensing units are arranged into a cascade form matrix, the cladding layer is located at the periphery of the core layer, a maximum depth of the groove is larger than a thickness of the cladding layer to expose at least a vertical-section surface of the core layer, and the plurality of the optical fiber sensing units is respectively connected with the light source and the optical signal detector by the plurality of fibers.

18. The apparatus as claimed in claim 17, wherein the surface of the groove is coated with a metallic layer.

19. The apparatus as claimed in claim 18, wherein the metallic layer is made of gold or silver.

20. The apparatus as claimed in claim 17, wherein a biomolecule layer is formed on the surface of the groove.

21. The apparatus as claimed in claim 17, wherein the light source is a laser diode.
